(19) United States
(12) Patent Application Publication
(10) Pub. No.: US 2020/0373700 A1
(43) Pub. Date: Nov. 26, 2020

(54) WIRE CONNECTOR

(71) Applicant: ISC ENGINEERING, LLC, Chino, CA (US)

(72) Inventors: Steven Lee WILLING, Encinitas, CA (US); Harald Markus GIEBEL, Chino, CA (US); Matthew Jay DUFFIELD, Riverside, CA (US); Ryan Timothy JENNER, Corona, CA (US); Tyler James GOODEN, Perris, CA (US)

(73) Assignee: ISC ENGINEERING, LLC, Chino, CA (US)

(21) Appl. No.: 16/422,315

(22) Filed: May 24, 2019

(51) Int. Cl. H01R 13/405; H01R 13/52; H01R 43/24

(52) U.S. Cl. CPC H01R 13/405; H01R 43/24; H01R 13/521; H01R 13/5219

(57) ABSTRACT

A connector For wires to be connected in harsh environment applications. This approach uses low pressure casting techniques. An alternative embodiment uses a thin, rigid stabilizer to position one or more contacts inside of the connector shell. Foamed polyurethane is injected inside the connector shell in liquid form. This encapsulates the stabilizer (when used) and forms an insulator around the contacts and wires. The polyurethane is bonded to the inside of the connector shell. The bonding strength of the polyurethane will form an environmental seal suitable for harsh environmental applications. In some cases a primer may be pre-applied to the inside of the connector shell the contacts, the wires, or the stabilizer to enhance the bonding of the polyurethane.

### FIELD OF INVENTION

The apparatus and method described and shown herein relate generally to connectors for wires and more particularly to a connector for electrical wires and contacts that provides a seal for the protection of their functional integrity in harsh environments.

### BACKGROUND OF THE INVENTION

Connectors for wires are used in a variety of applications to give users the ability to connect and disconnect electrical circuits with respect to apparatus or other circuits. A typical electrical connector tor harsh environment applications includes metal contacts that are attached to individual wires which are typically grouped in a multi-wire cable. The contacts are positioned in an insulation that is made of a non-conductive material. The insulator is typically molded from a thermoplastic material and includes cavities that retain and position the contacts as well as providing electrical insulation. The insulator is positioned in a shell that can he made of either a conductive or a non-conductive material. The shell provides mechanical support and protection for the insulator. External to the shell is the coupling which enables one connector to be securely connected or coupled to another connector or apparatus. In applications where protection from moisture or fluids is required, gaskets or wire seals can be added to seal the front and rear surfaces of the connectors. The insulator is typically bonded to the inside of the connector shell using an appropriate adhesive. In applications where strain relief is needed to protect the wires where the wires enter the connector a backshell or an overmolded flex relief device is often added.

The cost to manufacture, align, and assemble these components for use in harsh environments tends to drive up the costs to manufacture such connectors. This complexity also increases the cost to assemble electrical connectors onto wire and cable assemblies.

Lower cost connectors often omit the backshells, gaskets, and wire seals if environmental sealing and vibration protection are not required. They also often combine the insulator, shell, and coupling mechanism into a single molded part. Unfortunately, this approach often does not meet the performance requirements for connectors that will be used in outdoor, high reliability, or other high performance environments.

Efforts have been made to mold insulators and shells directly over the contacts and wires using conventional molding materials, such as PVC and nylon. The mold clamping pressures for these materials are typically in the range of 10 to 50 tons. This results in high injection pressure that make it very difficult to hold the contacts in their precise locations within the shell during the molding process. If the contacts are not held firmly in place they can be pushed out of position. If the contacts are pushed back into the connector there may not be enough overlap between the male and female contacts to ensure proper mating. Likewise, if the contacts are displaced to the side or twisted they likely will not be in the correct position to ensure proper alignment for mating with the second connector. Additionally, if the contacts are not clamped tightly enough mold material can escape through the gaps. Conversely, if the contacts are clamped too tightly they car. be damaged. Hence, these applications have generally been limited to low precision designs with a relatively small number of large contacts and are not typically suitable for higher density, tine contacts, or high precision designs.

Other designs have molded the insulator directly inside of a connector shell. High pressure techniques suffered from the same limitations as mentioned above. Low pressure molding of hot melt materials such as polyamide has also been attempted. They have in this way been able to reduce the misalignment challenges, but the materials must be heated during the low pressure molding processes. Typically elevated temperatures involved range from about 260° F. to about 400° F. The thermal expansions and contractions that take place tend to work against the formation of strong bonds between the insulator and the connector shell. In some cases a physical gap can form between the insulator and the connector shell, which can undermine the sealing of the connector. These materials also suffer from poor surface bonding to metal and plastic surfaces, which can lead to poor scaling and possible failure of the electrical integrity of the connector.

Epoxies and other two-part thermoset materials that could be mixed and then poured into the connector shells in a process commonly referred to as “potting” have provided some promising results, but have had limited market success. This is due, at least in part, to the high cost of the materials and the lengthy process to dispense the material and cure the epoxy. Typical curing times (or these epoxies range from 30 minutes to over 24 hours. This is due in part to the need to remove air bubbles horn the epoxies before they harden. A lengthy “self leveling” process or the use of vacuum chambers are typically required to eliminate air bubbles. This makes it difficult to use potting to mass produce insulators. Instead, this approach is used primarily for low volume, high cost applications.

An alternate approach is to use epoxies that can be cured using ultraviolet light. These epoxies are best suited for thin film applications where the ultraviolet light can reach the interior of the epoxy because as these materials harden they form a barrier to the further penetration of ultraviolet light into the material. Additionally, the connector shells will typically, at least partially, block the transmission of ultraviolet light. The thickness of the insulators is generally too large for ultraviolet-cured epoxies to be a viable alternative for potting.

### SUMMARY OF EMBODIMENTS OF THE INVENTION

A purpose of this concept is to alleviate or overcome the shortcomings and limitations of the prior art identified above. Embodiments of the invention provide a connector for wires that is sealed to maintain physical and electrical integrity in harsh environmental conditions, is economical and is constructed at low pressures and low temperatures. This structure and the process involved enable high throughput, insulative integrity, and repeatability. When completed this connector is enabled to be securely connected to another connector.

A specific two-part cast foamed polyurethane material provides the internal sealing and electrical insulation necessary for a wire connector to be effective and safe in harsh environments. The specific polyurethane can be cast or sprayed into a mold (here the mold is the connector shell) at non-elevated temperatures and pressures. This alleviates the possibility of displacing or misaligning contacts within the connector shell that could result from high injection pressures. Because elevated temperatures are not required, problems that can be induced by thermal expansions and contractions by prior known processes are effectively eliminated in the present concept.

Further, the specific low teaming polyurethane formulation employed in this inventive concept has closed cell foam with integral skin and has size- and volume-limited microcellular air bubbles which do not demand lengthy setting or curing times. This further enables production times to be as low as one to two minutes, thereby reducing the cost of manufacturing and greatly increasing throughput by decreasing cycle times.

The foamed polyurethane formulation employed in embodiments of this invention also provides higher levels of surface bonding and a lower coefficient of thermal expansion than some known materials, such as polyamide. Contrary to possible contraction problems that can be suffered when using heated materials inside the connector shell to provide electrical insulation, bonding, and sealing, the polyurethane used in this concept provides isostatic expansion. That expansion enhances the sealing property of the polyurethane to the inner surfaces of the connector shell by creating outward pressure. That outward expansion, which ranges from about 0% to about 100%, enables the foamed poly urethane to completely rill all aspects of the cavity, that is, the inside of the connector shell in which the wire contacts reside.

The casting process injects the foamed polyurethane material under low pressure and at temperatures that arc essentially room, or ambient, temperature. This has two key advantages versus conventional technologies. First, the low injection pressure limits the potential for components Inside the connector shell to be shifted in position. Second, it eliminates the thermal expansion and contraction which are typical of the prior art during the injection process which could result in disrupting the surface bonding of the polyurethane to the inner surface of the connector shell and to the electrical contacts. As an alternative embodiment, for medium and high wire-density configurations (typically more than three wires and contacts), a stabilizer can be used. The stabilizer is relatively thin and flat. formed with through holes by which the wire contacts are aligned and held in place during the polyurethane application part of the assembly process. A benefit of using the stabilizer when a number of relatively fine wires are being connected by the connector of this concept, maintains proper spacing of the contacts and ensures that the tips of the contacts remain coplanar. This is particularly evident when as many as 100 wires are being connected by this connector.

In some circumstances it may be desirable to enhance the bonding of the polyurethane to the connector shell the contacts, the wires, and the stabilizer (when used). For this purpose various steps may be taken such as using a primer, or plasma etching, or using an acid, or cleaning and degreasing, or other means to improve bonding of the polyurethane to the connector shell and the structure internal to the shell.

### BRIEF DESCRIPTION OF THE DRAWING

The purposes, advantages, and benefits of this concept will be clearly understood from the following description, when read in conjunction with the accompanying drawing, in which:

FIG. 1 is a perspective view of a prior an connector;

FIG. 2 is a sectional view of the prior art connector;

FIG. 3 is a sectional view of a prior art connector showing examples of wires and contacts mounted therein;

FIG. 4A is a perspective view of the connector of an embodiment of this invention without the polyurethane shown prior to the assembly step;

FIG. 4B is a perspective view of the connector of an embodiment of this invention without the polyurethane shown prior to the assembly step, with a stabilizer as an alternative embodiment;

FIG. 5 is a perspective view of the connector of FIG. 4A in assembled form and prior to combining with polyurethane;

FIG. 6 is a perspective exploded view of the connector according to foe FIG. 4B embodiment of foe present invention;

FIG. 7 is a sectional view of the fully assembled connector of FIG. 6;

FIG. 8 is a sectional view of an alternative embodiment showing an overmolding wire stress relief device;

FIG. 9 is a flow chart showing the process of an embodiment of the invention; and

FIG. 10 is a flow chart showing the process of an embodiment of the invention, with a stabilizer in accordance with FIG. 4B.

### DETAILED DESCRIPTION OF THE PREFERRED EMBODIMENTS

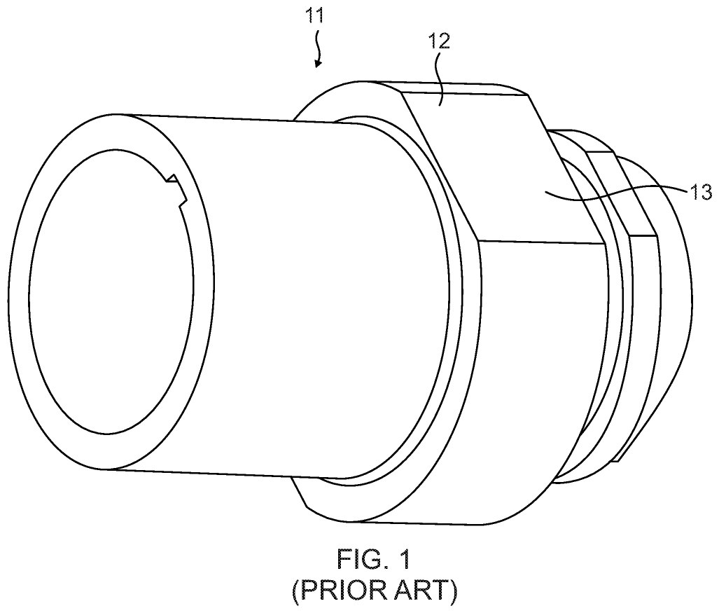

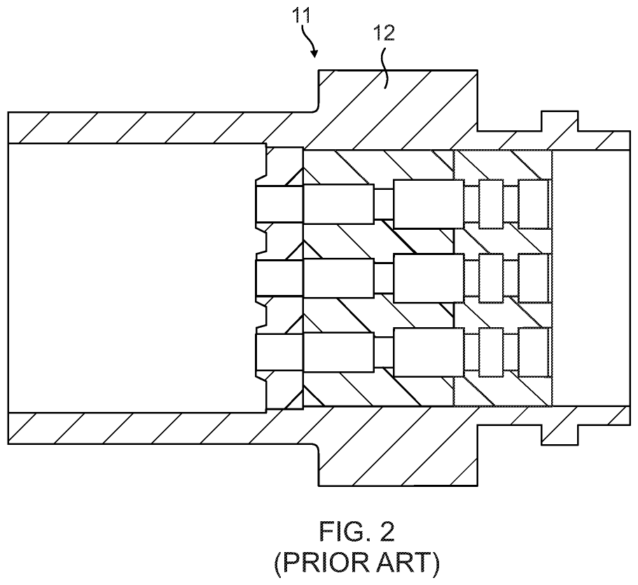

For perspective purposes, FIGS. 1-3 show an example of a prior art connector 11. Connector shell 12 is configured to connect with another connector device, which could be on an installation or it could be a device to splice together two multi-wire cables. While not shown in FIGS. 1-3, shell 12 would normally have external or internal threads by which secure connections could be made. The flat external surface 13 provides a reference point for alignment of the connector in cases where it is mounted on a panel or enclosure.

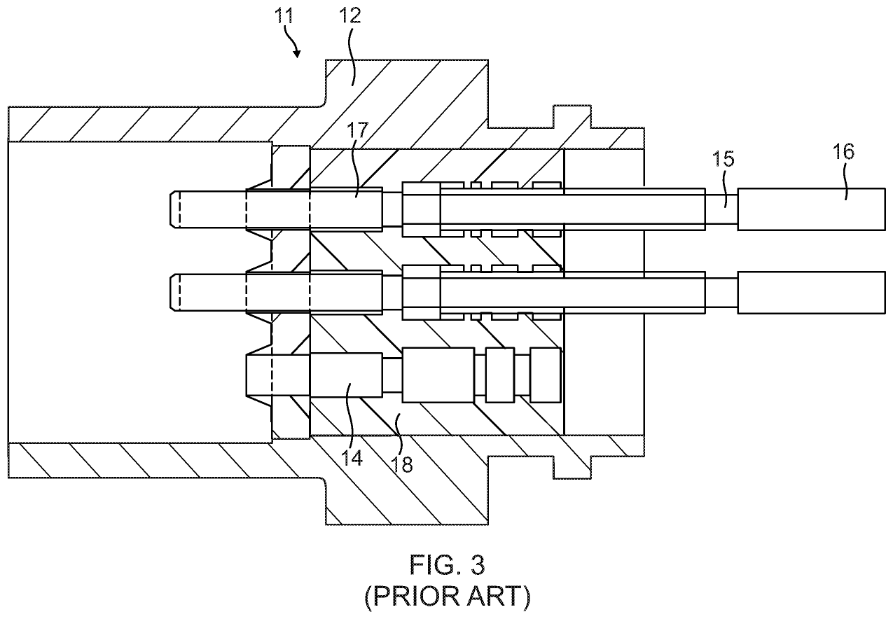

Incoming wires 15, two of which are shown in FIG. 3 with their insulative jackets 16, are terminated by contacts 17, which are, in turn, secured within shell 12. A third contact position 14 is shown without any wire or contact mounted therein.

The interior of shell 12 is filled with insulative material 18 to keep the contacts separate and insulated from each other and from the shell, which is typically made of metal. The insulative material could be polyamide or an epoxy, having the limitations previously described.

Limitations and disadvantages of known wire connectors have been enumerated above.

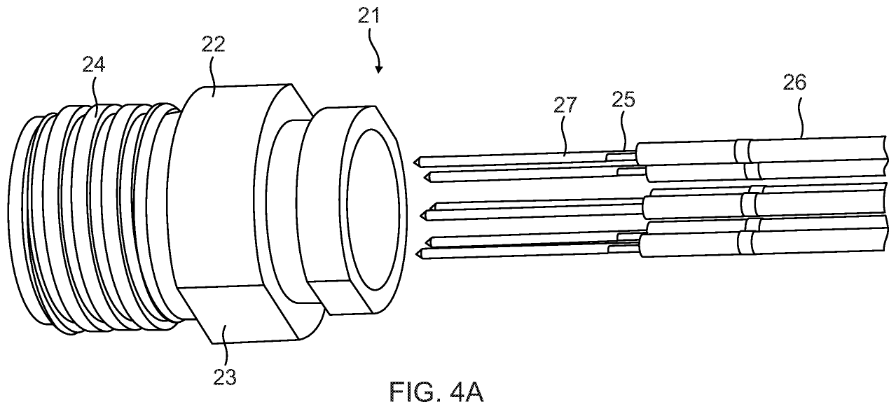

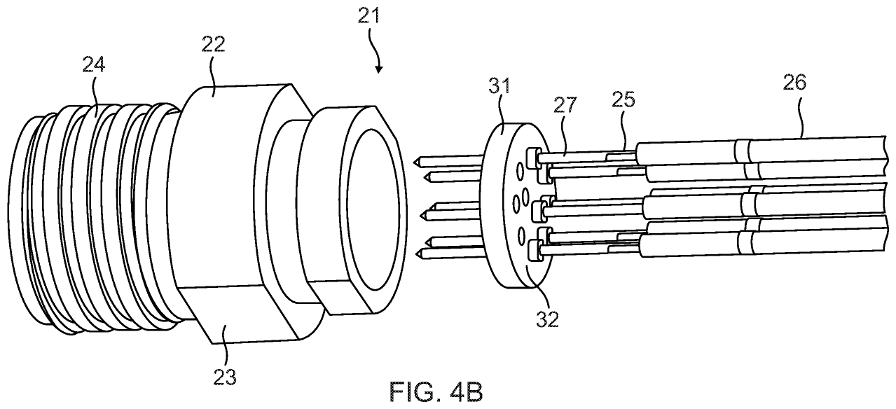

An embodiment of the present invention is shown in FIGS. 4-7. Connector 21 is comprised of shell 22 having flat surface 23 and external threads 24 which are configured to engage matching threads in a device or other connector (not shown) to which connector 21 may be connected. Wires 25 having insulative sheaths 26 are individually connected to contacts 27.

FIG. 4A is the basic embodiment as it might be employed when the wires/contacts are relatively few (typically 1-5) and each wire is relatively large.

An alternative embodiment is shown in FIG. 4B with the addition of stabilizer 31. The stabilizer is an assembly tool which would typically be used when the wires are relatively fine, or if there are about five and any greater any number of wires, up to 100 or possibly more. The term “fine” is understood here to mean American Wire Gauge (AWG) size 16 or smaller in diameter. So wires larger than size 16 in diameter would be “relatively large.” It is contemplated that typical wire sizes employed in this connector will fall between 32 and 24 AWG.

In the FIG. 4B embodiment there is shown stabilizer 31 having through holes 32. Contacts 27 extend through the stabilizer equally so that the ends of the contacts arc substantially coplanar. The stabilizer is an optional device that is used during the assembly process when there arc several or multiple wires and contacts involved. In situations where fewer than about five wires 25 are being secured in shell 22, a stabilizer may not be necessary, as in FIG. 4A. It could still be used with such few wires but its assembly function would then be diminished.

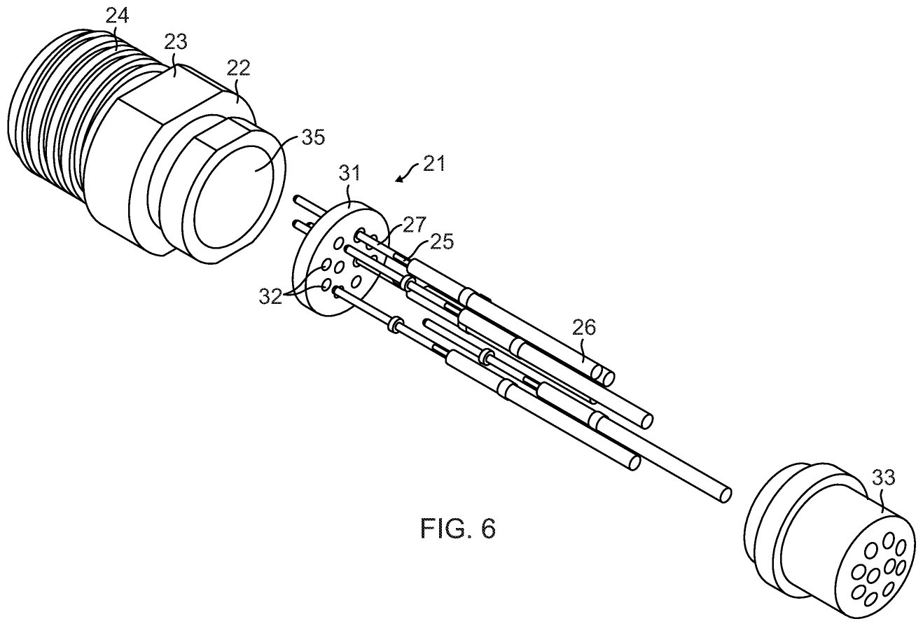

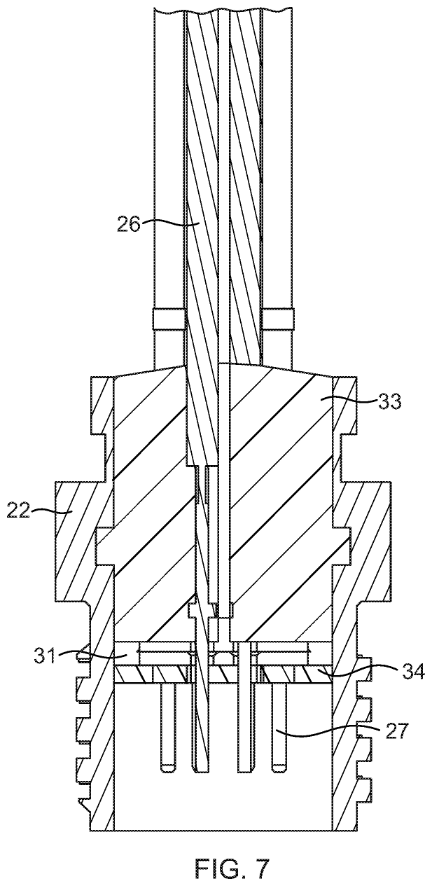

After the wires, contacts, and stabilizer, if used, are placed in shell 22, as shown in FIG. 6, the polyurethane 33 is applied. The particular polyurethane formulation chosen to be part of this concept enables that material to be injected into shell 22 under low pressure. The term “low pressure” as used here, is defined as about 30-40 psi. Further, the polyurethane is a slightly viscous liquid at room temperature and is. thus, easily injected through opening 35 (FIG. 6) to fill shell 22 and closely surround and insulate the contacts from one another and from the interior of the shell. The finished polyurethane element takes on the form of the interior of the shell, as shown in FIG. 7. As the term “room temperature” is used herein, it means between about 80° F. and 120° F. The term “slightly viscous” is intended to mean only slightly more viscous than water.

Also shown in FIG. 7 is interfacial gasket 34. This is located between the two ha vies of the mating connectors and eliminates any air gap between the insulators.

Further characteristics of the polyurethane chosen for this connector are that it is electrically insulative and that it expands as ft cures, the expansion being greater than 0% and less than 100%, thereby sealing the interior of the shell with the contacts therein and providing electrical insulation with respect to all elements within the shell. Preferably, the polyurethane formulation chosen has a coefficient of expansion of about 35%. The limited expansion results, in part, from the fact that the polyurethane is not injected at an elevated temperature, which typically would result in a contraction, which can leave air bubbles and gaps, which can result in less than complete electrical insulation. The type of expansion of polyurethane 33 as it cools may be termed mechanical or possibly, chemical. It is an isostatic process.

A further aspect of this polyurethane is that it preferably sets or cures in one to two minutes, thereby enabling rapid throughput for making multiple connectors according to this concept. Under certain circumstances, the curing time could be as long as 15 minutes. This short curing time is in contrast to prior art epoxies and polyamides which normally arc injected at elevated temperatures (260-400° F.) and take 30-60 minutes, and even as much as 24 hours, to cure, all the while shrinking as it cools.

The polyurethane employed in this connector has the following characteristics:
It is liquid at ambient temperature
Its viscosity is between that of water (1 centipose (cP) at 25 degrees C.) and that of castor oil (650 cP at 25 degrees C).
It is applied to the mold (connector shell) at ambient temperature
It is applied to the mold at very low pressure (30-40 psi)
After being applied to the mold it isostatically cures at ambient temperature
It cures normally within no more than two minutes
It expands with microbubble foam expansion
The expansion is uniform throughout and is more than 0% and less than 100%
When cured it has a durometer Shore A hardness of 30-70, that is, it is on the flexible side of hardness

Further, since this polyurethane is injected at just sufficient pressure to enable it to fill the shell cavity, it does not disturb the placement or relative positions of the electrical contacts within the shell as it uniformly expands isostatically.

The polyurethane formulation is comprised primarily of polyol A resin and an isocyanate B catalyst. The constituent ratios are about 32 to 68 for the polyol A and isocyanate B, respectively, with normal and well known other minor or trace constituents that arc inactive with respect to the functional characteristics set out above.

The shell is normally metal so the electrical insulative properties of the polyurethane are integral to the proper construction and functioning of the connector. Even if the shell can be made from some type of rigid plastic, the insulative properties are still necessary to keep the contacts separate and apart from each other and to completely fill and seal to the shell so that no foreign substance can enter and thereby compromise the electrical integrity of the connector.

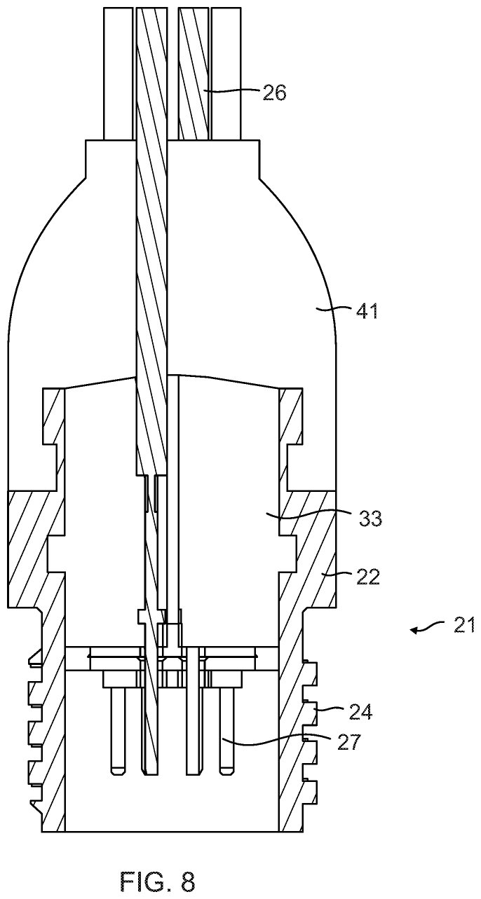

An alternative embodiment is shown if FIG. 8 where strain relief hood 41 can be included to provide even greater environmental protection while at the same time the incoming wires are being secured from possible damage that could result from bending or harsh handling.

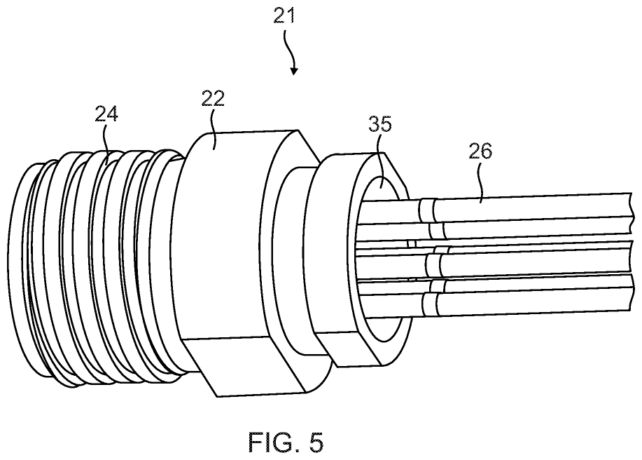

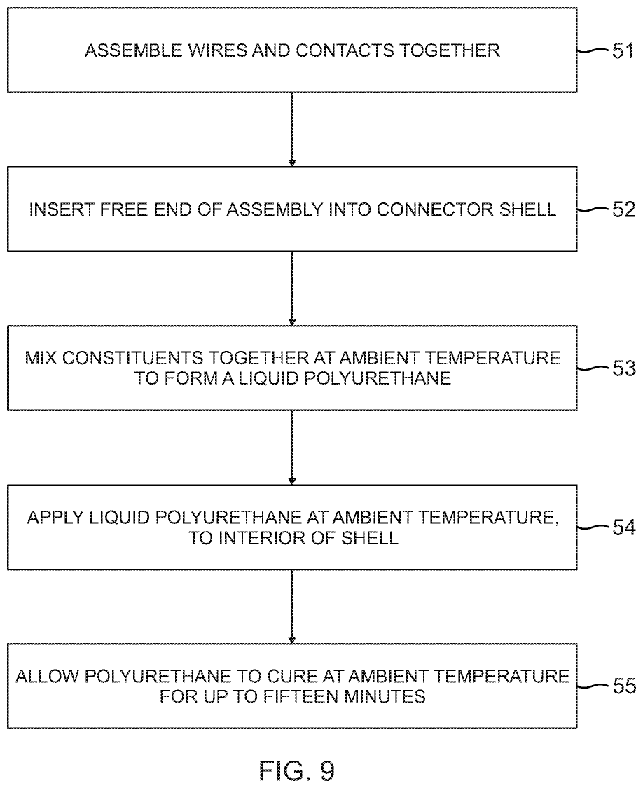

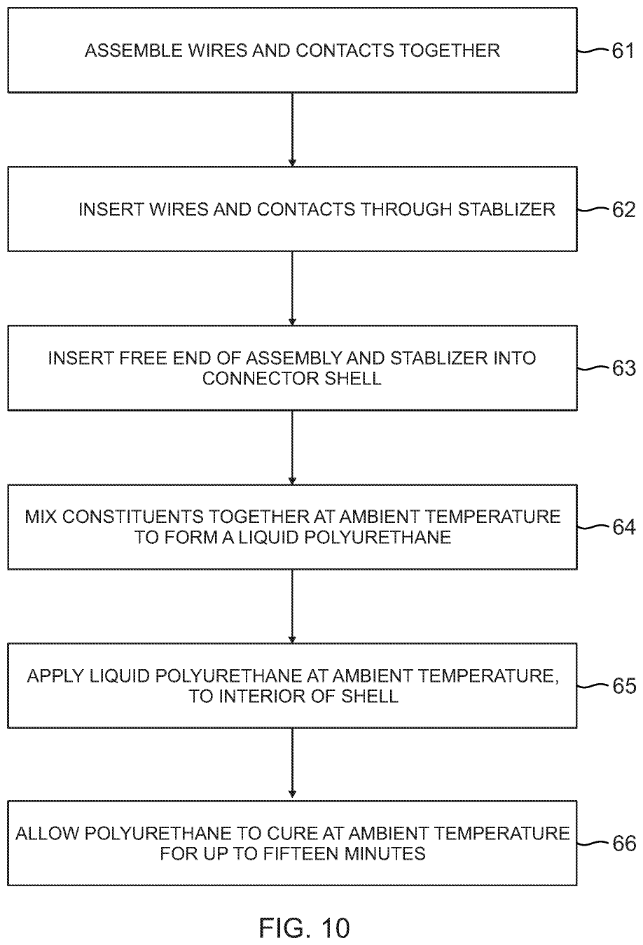

The methods of constructing the connectors of FIGS. 4-7 are shown in FIGS. 9 and 10. Block 51 calls for the initial assembly of contacts to the free ends of the wires that are to be mounted in connector shell 22. Step 52 is representative of FIGS. 4A and 5, where the assembled wires and contacts are inserted into one end of the shell.

The liquid polyurethane is formed by combining about 68% isocyanate B with about 32% polyol A at ambient temperature in step 53.

Then, before a chemical reaction can get underway, the liquid polyurethane is poured or injected (step 54) into the connector shell of FIG. 5 around the contacts, to form polyurethane insulative element 33 (FIG. 6).

The quick curing polyurethane 33 is then cured tor, preferably, one to two minutes (step 55) at ambient temperature to form the final insulative element 33 (FIGS. 6 and 7). The cure time could be as long as 15 minutes under certain circumstances. The insulative element, in its final, cured, form, has a flexible Shore A hardness of 30-70, preferably about 50.

FIG. 10 shows the method as modified to incorporate the stabilizer of FIG. 4B. The initial assembly of contacts and wires are depicted in block 61.

In block 62 the wires/contacts are inserted through the holes in stabilizer 31. Then steps 63-66 are the same as respective steps 52-55 in FIG. 9.

1. A connector for wires having ends, the connector being configured to be connected at the ends of a plurality of wires, the connector comprising:
a contact secured at the end of each wire to form the plurality of wires/contacts;
a shell adapted to be coupled to an external structure at one end, said shell having an interior and being formed with an open end opposite said one end, the ends of the wires/contacts extending into the shell interior; and
closed-cell cast foamed polyurethane material filling the interior of said shell and completely sealing the interior of said shell and sealing the wires/contacts within said shell, said foamed polyurethane having the properties: of being liquid when cast into the shell interior at ambient temperature; of having a coefficient of expansion of 0-100% at ambient temperature; and of expanding as it cures to apply a positive pressure to the interior of said shell.

2. The connector of claim 1, and further comprising:
a stabilizer within said shell and positioned between said open end and said one end, each of the wires/contacts being positioned through an individual hole through said stabilizer, said stabilizer being sealed by said cast foamed polyurethane.

3. The connector of claim 1, wherein the coefficient of expansion at ambient temperature is approximately 35%.

4. (canceled)

5. The connector of claim 1, wherein said foamed polyurethane is applied to the interior of said shell at a pressure of between about 30 psi and about 40 psi.

6. The connector of claim 1, wherein said cast foamed polyurethane is applied to the interior of said shell using a pressure no more than that which is sufficient to fill said shell with said polyurethane.

7. The connector of claim 1, and further comprising an interfacial gasket located toward said one end of said shell from said cast foamed polyurethane and configured to maintain said wires/contacts separate from each other.

8. The connector of claim 1, and further comprising a surface treatment to improve bonding between the foamed polyurethane and said shell and said wires/contacts, the surface treatment being selected from the group consisting of a primer and a plasma etching.

9. A method for making a connector for plurality of wires, the method comprising:
attaching a connector to the end of each wire of the plurality of wires to form a plurality of wires/contacts;
inserting the ends of the wires/contacts through one end into the interior of a connector shell, the other end of the connector shell being adapted to be engaged to a receptacle to connect the plurality of wires to external wires;
mixing together about 32% polyol A resin and about 68% isocyanate B catalyst to form a closed-cell liquid foamed polyurethane;
casting the liquid foamed polyurethane into the connector shell around the wires/contacts within the connector shell to fill and seal the connector shell, the foamed polyurethane being in liquid form at ambient temperature when cast in the shell, the injection pressure being about 30-40 psi; and
curing the cast foamed polyurethane at ambient temperature for no more than fifteen minutes, the curing process resulting in expanding the foamed polyurethane to apply a positive pressure to the interior of the shell.

10. The method of claim 9, wherein the formulation of the cast foamed polyurethane being such that, as it cures within the connector shell at ambient temperature, the cast foamed polyurethane expands volumetrically to more than zero percent and to less than 100%.

11. The method of claim 9, wherein the cast foamed polyurethane expands by about 35%.

12. The method of claim 10, wherein the time for curing the cast foamed polyurethane is one to two minutes.

13. The method of claim 10, wherein, when curing is complete, the cast foamed polyurethane within the connector shell has a durometer rating of about Shore A 30-70.

14. The method of claim 13, wherein the durometer rating is about Shore A 50.

15. (canceled)

16. The method of claim 9, and comprising the further step of inserting the wires/contacts through holes in a stabilizer after the attaching step and prior to the step of inserting the wires/contacts and stabilizer into the connector shell.

17. The method of claim 9, wherein the foamed polyurethane is cured isostatically.
